(19) United States
(12) Patent Application Publication
(10) Pub. No.: US 2026/0109099 A1
(43) Pub. Date: Apr. 23, 2026

(54) POLYPROPYLENE BLENDS FOR THERMOFORMING

(71) Applicant: AMCOR FLEXIBLES NORTH AMERICA, INC., Neenah, WI (US)

(72) Inventors: TYLER J. THEOBALD, Neenah, WI (US); Michael D. PRISCAL, Neenah, WI (US); Kevin P. NELSON, Appleton, WI (US); Yuan LIU, Apex, NC (US)

(21) Appl. No.: 19/123,650

(22) PCT Filed: Nov. 8, 2022
(86) PCT No.: PCT/US2022/049222

§ 371 Date: Apr. 23, 2025

(51) Int. Cl. B29C 48/08; B29C 48/00; B29C 48/21; B29C 48/22; B29K 23/00; B29L 7/00; B29L 9/00; B29L 31/00; C08J 3/24

(52) U.S. Cl. CPC B29C 48/08; B29C 48/0017; B29C 48/022; B29C 48/21; B29C 48/22; C08J 3/247; B29K 2023/086; B29K 2023/12; B29K 2995/0065; B29K 2995/0097; B29L 2007/008; B29L 2009/00; B29L 2031/712; C08J 2351/06

(57) ABSTRACT

A thermoformable polymeric film includes a polymeric layer. The polymeric layer includes at least 50% polypropylene by weight, at least 5% tackifier by weight, and from 0.1% to 5% crosslinker by weight. The polypropylene comprises impact polypropylene. The layer comprises at least 5% impact polypropylene by weight.

### FIELD

This disclosure relates generally to films, such as recyclable films, suitable for thermoforming into packaging components.

### INTRODUCTION

Polypropylene is a highly adaptable semi-crystalline material that is readily recycled. However, polypropylene is not typically used for thermoforming in form/fill/seal packaging lines due to its narrow thermoforming temperature window. More amorphous materials are typically employed in such thermoforming due to their wider thermoforming temperature windows.

### SUMMARY

The present disclosure describes, among other things, polypropylene blends for forming films suitable for thermoforming. The blends include a tackifier, a crosslinker and an impact polypropylene. The combination of the tackifier, impact polypropylene, and a crosslinker in defined amounts in the polypropylene blends provides films having, among other things, broadened thermoforming temperature windows and suitable sag resistance and other properties, such as, for example, toughness or impact strength for practical use in thermoforming, particularly on form/fill/seal lines which have short preheating dwell times.

In one or more aspects, the present disclosure describes a thermoformable polymeric film comprising a polymeric layer. The polymeric layer comprises at least 50% polypropylene by weight, at least 5% tackifier by weight, and from 0.1% to 5% crosslinker by weight. The polypropylene comprises impact polypropylene. The layer comprises at least 5% impact polypropylene by weight.

In one or more embodiments, the film has a thermoforming temperature window of 5 degrees C. or greater, such as 10 degrees C. or greater, or 15 degrees C. or greater.

A thermoformed article may comprise the thermoformable polymeric film.

In one or more aspects, the present disclosure describes a blend for forming a recyclable layer of a thermoformable polymeric film. The blend comprises at least 50% polypropylene by weight, at least 5% tackifier by weight, and from 0.1% to 5% crosslinker by weight. The polypropylene comprises impact polypropylene. The blend comprises at least 5% impact polypropylene by weight.

In one or more aspects, the present disclosure describes a method for forming a thermoformable film layer. The method comprises blending a polypropylene matrix polymer, an impact polypropylene polymer, a tackifier, and a crosslinker; and forming the film layer from the blend. The film layer comprises at least 50% polypropylene by weight, at least 5% tackifier by weight, and from 0.1% to 5% crosslinker by weight. The polypropylene comprises impact polypropylene. The layer comprises at least 5% impact polypropylene by weight.

### BRIEF DESCRIPTION OF THE DRAWINGS

The following detailed description of specific embodiments of the present disclosure can be best understood when read in conjunction with the following drawings, where like structure is indicated with like reference numerals and in which:

FIGS. 1-7 are schematic cross-sectional views of embodiments of films according to the present disclosure.

FIG. 8 is a schematic perspective view of thermoformed base component including 10 cavities according to an embodiment of the present disclosure.

FIG. 9 is a schematic top view of an embodiment of a thermoformed base component showing 12 cavities and a flange.

FIG. 10 is a schematic cross-sectional view of an embodiment of a package including thermoformed base component, a product and a lid component.

FIG. 11 is a schematic of a cross-section of an embodiment of a lid component for a packaged product.

FIGS. 12A-B, FIGS. 13A-B, FIGS. 14A-B, FIGS. 15A-B, FIGS. 16A-C, FIGS. 17A-C, and FIGS. 18A-B are images of films as described in the Examples.

The drawings show some but not all embodiments. The elements depicted in the drawings are illustrative and not necessarily to scale. The same (or similar) reference numbers denote the same (or similar) features throughout the drawings. However, it will be understood that the use of a number to refer to a component in a given figure is not intended to limit the component in another figure labeled with the same number. In addition, the use of different numbers to refer to components is not intended to indicate that the different numbered components cannot be the same or similar to other numbered components.

### DETAILED DESCRIPTION

This disclosure, among other things, relates to polypropylene blends for forming films suitable for thermoforming and to films comprising polypropylene layers suitable for thermoforming. The blends include polypropylene, a tackifier, a crosslinker, and impact polypropylene. Films or layers formed from such blends may have properties suitable for thermoforming, such as a broadened thermoforming temperature window, sag resistance, and other properties, such as, for example, toughness or impact strength.

Polypropylene is a semicrystalline material that has a narrow thermoforming temperature window. As described herein, adding a tackifier may allow for more polypropylene chain movement at temperatures near the Tg of the tackifier, making the polypropylene film or layer more stretchable. The result of tackifier addition may extend the lower end of the thermoforming temperature window. However, the addition of too much tackifier may make a film or layer formed from the blend brittle. As described herein, the addition of impact polypropylene may be added to combat the brittleness and toughen or increase the impact strength of the film and resulting thermoformed article.

A crosslinker may serve to enhance the melt strength of the material, which may increase the upper end of the thermoforming temperature window. The crosslinker may also serve to increase the number of times a film or article may be reused, further enhancing recyclability.

### Polypropylene

The blends, layers, and films described herein comprise polypropylene (PP). As used herein, “polypropylene” is a polymer formed from a propylene monomer or a propylene monomer and one or more other monomers. The PP may be a homopolymer or a copolymer. The PP may be unmodified or modified. For example, the PP may be modified by, for example, derivatization after polymerization to add functional groups or moieties along the polymeric chain.

In some embodiments, the PP is a homopolymer. In some embodiments, the PP is a copolymer. In some embodiments, the PP is a random copolymer. In some embodiments, the PP is blend of a homopolymer and a copolymer. In some embodiments, the PP is a blend of a homopolymer and a random copolymer.

The PP may contain at least 50% propylene by weight, such as at least 60% PP by weight, at least 70% PP by weight, at least 90% PP by weight, or about 100% PP by weight. In some embodiments, PP contains from about 80% PP by weight to about 99.5% PP by weight.

In some embodiments, the PP cumulatively contains less than 50% by weight comonomer. In some embodiments, the PP contains 40% by weight or less comonomer, 30% by weight or less comonomer, 20% by weight or less comonomer, or 10% by weight or less comonomer.

In some embodiments, the PP comprises a comonomer selected from ethylene and alpha-olefins having from 4 to 12 carbon atoms. In some embodiments, the PP comprises ethylene. In embodiments, the PP comprises a comonomer selected from ethylene and alpha-olefins having from 4 to 12 carbon atoms at a weight percent from about 0.1% to about 20%, such as from about 0.5% to about 15%, about 0.5% to about 10%, about 0.5% to about 8%, 1% to about 15%, about 1% to about 10%, about 1% to about 8%, 2% to about 15%, about 2% to about 10%, or about 2% to about 8%.

The blends and layers comprising PP may have any suitable amount of PP. In some embodiments, the blends and layers comprise 50% by weight or more (at least 50%) PP, such as at least 60% by weight PP, at least 70% by weight PP, at least 80% by weight PP or at least 90% by weight PP. In some embodiments, the blends and layers comprise less than 95% by weight PP. In some embodiments, the blends and layers comprise from about 50% by weight PP to about 95% PP, such as from about 50% PP to about 90% PP, from about 50% PP to about 80% PP, from about 50% PP to about 70% PP, from about 50% to about 60% PP, from about 60% by weight PP to about 95% PP, from about 60% PP to about 90% PP, from about 60% PP to about 80% PP, from about 60% PP to about 70% PP, from about 70% by weight PP to about 95% PP, from about 70% PP to about 90% PP, from about 70% PP to about 80% PP, from about 80% by weight PP to about 95% PP, or from about 80% PP to about 90% PP.

In some embodiments, PP comprise isotactic PP. The isotactic PP may be mostly, highly, or predominantly isotactic PP. The layers, films, or packages described herein may comprise PP having any suitable molecular weight for forming a film or layer. Mass flow rates may relate to molecular weight. In embodiments, the PP has a mass flow rate of from about 0.5 g/10 min (grams per 10 minutes) to about 10 g/10 min, such as from about 0.6 g/10 min to about 8 g/10 min, from about 0.8 g/10 min to about 6 g/10 min, or from about 2 g/10 min to about 4 g/10 min. Mass flow rate may be measured according to ASTM D1238-20 (Sep. 3, 2020), Standard Test Method for Melt Flow Rates of Thermoplastics by Extrusion Plastometer.

An example of a PP homopolymer that may be used in a blend or layer described herein is 6021N polypropylene homopolymer (Braskem INSPIRE 6021N). An example of a polypropylene random copolymer that may be used in a blend or layer described herein is 6232 polypropylene copolymer (e.g., from Total or TotalEnergies).

### Impact Polypropylene

At least some of the PP in the blends and layers described herein is an impact polypropylene. As used herein, “impact polypropylene” is a copolymer produced through the polymerization of propylene and ethylene, which has a heterophasic, predominantly amorphous structure inside a polypropylene homopolymer matrix. Impact PP may be produced in any suitable manner. In some embodiments, impact PP is produced in series reactors where the rubber phase is produced in one reactor and the homopolymer is produced in another. The characteristics of the resin depend not only on the rubber content but also on the sizes of the rubber domains.

Impact PP may have any suitable mass flow rate. In some embodiments, impact PP has a mass flow rate of from about 0.4 g/10 min to about 0.8 g/10 min.

An example, of an impact polypropylene is a propylene homopolymer containing a co-mixed propylene random copolymer phase that has an ethylene content of 45% to 65%. Examples of suitable impact PP that may be included in the blends or layers include Total (TotalEnergies) 4170, LyondellBasell Pro-fax 7823, and LyondellBasell Adflex Q 100F. Total 4170 has the following properties: mass flow rate (MFR)=0.8 g/10 min; density=0.905 g/cm³; Tm=160-165° C. Profax 7823 has the following properties: MFR=0.45 g/10 min; density=0.90 g/cm³. Adflex Q 100 F has the following properties: MFR=0.6 g/10 min; density=0.88 g/cm³; Tm=142° C.

In some embodiments, the blends or layers comprise at least 5% impact PP by weight, such as at least 10% impact PP by weight, at least 15% impact PP by weight, at least about 20% impact PP by weight, at least about 25% impact PP by weight, at least about 30% impact PP by weight, or at least about 35% impact PP by weight. In some embodiments, the blends or layers comprise less than 50% impact PP by weight, such as less than 40% impact PP by weight. In some embodiments, the blends or layers comprise about 10% to about 30% impact PP by weight, about 5% to about 35% impact PP by weight, or 10% to about 25% impact PP by weight, or about 10% to about 20% impact PP by weight.

### Tackifier

The blends and layers described herein may comprise any suitable tackifier. For purposes of this disclosure “tackifier” and “hydrocarbon resin” are used interchangeably. The tackifier may be present in the blends and layers in any suitable amount. In embodiments, the tackifier is present in a blend or layer in an amount of 5% by weight or greater (“at least 5%”). 10% by weight or greater, 15% by weight or greater, or 20% by weight or greater. In embodiments, the tackifier is present in a blend of layer in an amount of 60% by weight or less, 50% by weight or less, or 40% by weight or less. In embodiments, the blend or layer comprises from 5% to 60% tackifier by weight, such as from 5% to 50% tackifier by weight, 5% to 40% tackifier by weight, 10% to 60% tackifier by weight. 10% to 50% tackifier by weight, 10% to 40% tackifier by weight, 15% to 60% tackifier by weight, 15% to 50% tackifier by weight, 15% to 40% tackifier by weight, 20% to 60% tackifier by weight, 20% to 50% tackifier by weight, 20% to 40% tackifier by weight. 10% to 25% tackifier by weight, 15% to 20% tackifier by weight, or the like.

The blends or layers may include any suitable tackifier. Suitable tackifiers include aliphatic hydrocarbon resins, at least partially hydrogenated aliphatic hydrocarbon resins, aliphatic/aromatic hydrocarbon resins, at least partially hydrogenated aliphatic aromatic hydrocarbon resins, aromatic resins, at least partially hydrogenated aromatic hydrocarbon resins, cycloaliphatic hydrocarbon resins, at least partially hydrogenated cycloaliphatic resins, cycloaliphatic/aromatic hydrocarbon resins, at least partially hydrogenated cycloaliphatic/aromatic hydrocarbon resins, polyterpene resins, terpene-phenol resins, rosin esters, rosin acids, grafted resins, and mixtures of two or more of the foregoing. The hydrocarbon resins may be polar or apolar.

The tackifier may be a low molecular weight product (molecular weight less than about 10,000 Daltons) produced by polymerization from coal tar, petroleum, citrus, or turpentine feed stocks.

A tackifier may comprise any of those hydrocarbon resins disclosed in U.S. Pat. No. 6,432,496, issued Aug. 13, 2002, or in U.S. Patent Application 2008/0286547, published Nov. 20, 2008, both of which are incorporated in their entireties in this application by this reference. More specifically, as a non-limiting example, the tackifier may include petroleum resins, terpene resins, styrene resins, cyclopentadiene resins, saturated alicyclic resins or mixtures of such resins. Additionally, as a non-limiting example, the tackifier may comprise hydrocarbon resin derived from the polymerization of olefin feeds rich in dicyclopentadiene (DCPD), from the polymerization of olefin feeds produced in the petroleum cracking process (such as crude C9 feed streams), from the polymerization of pure monomers (such as styrene, alpha-methylstyrene, 4-methylstyrene, vinyltoluene or any combination of these or similar pure monomer feedstocks), from the polymerization of terpene olefins (such as alpha-pinene, beta-pinene or d-limonene) or from a combination of such. The hydrocarbon resin may be fully or partially hydrogenated. Specific examples of hydrocarbon resins include but are not limited to Plastolyn® R1140 Hydrocarbon Resin available from Synthomer plc (Essex, UK), Regalite® T1140 available from Synthomer plc (Essex, UK), Arkon® P-140 available from Arakawa Chemical Industries, Limited (Osaka, Japan) and Piccolyte® S135 polyterpene resin available from Pinova, Inc. (Brunswick, GA).

### Crosslinker

The blends or layers described herein comprise a crosslinker. In some embodiments, the blends comprise a reversible crosslinker. Suitable reversible crosslinkers include crosslinkers that form crosslinks through ionic, hydrophobic, or other secondary interactions rather than through covalent bonds. In some embodiments, crosslinkers may increase melt viscosity and reduce sagging of a film or layer by increasing entanglements via long chain branching.

In embodiments, the crosslinker comprises an organic peroxide. A coagent may be used with the organic peroxide. The coagent may be used to reduce scission and enhance crosslinking. Examples of organic peroxides and coagents are described in, for example, U.S. Pat. No. 6,987,149 and Romani et al. (February 2002), Monitoring the chemical crosslinking of propylene polymers through rheology, Polymer 43(4):1115-1131, which are hereby incorporated herein by reference in their respective entireties to the extent they do not conflict with the disclosure presented herein.

In embodiments, the crosslinker produces long chain branched polypropylene by extrusion (grafting). See, for example, Didier Graebling (2002), Synthesis of Branched Polypropylene by a Reactive Extrusion Process. Macromolecules, American Chemical Society, 35(12): 4602-4610, which is hereby incorporated herein by reference in its entirety to the extent it does not conflict with the disclosure presented herein.

In embodiments, the crosslinker produces long chain branched isotactic polypropylene. See, for example, Weng et al. (2002), Long Chain Branched Isotactic Polypropylene, Macromolecules 35(10): 3838-3843, DOI: 10.1021/ma020050j, which is hereby incorporated herein by reference in its entirety to the extent it does not conflict with the disclosure presented herein.

In embodiments, the crosslinker produces long chain branched polypropylene via irradiation. See, for example, Krause et al. (5 Jan. 2006), Long-chain branching of polypropylene by electron-beam irradiation in the molten state, Journal of Applied Polymer Science, 99(1): 260-265 and Auhl et al. (11 Nov. 2004), Long-Chain Branched Polypropylenes by Electron Beam Irradiation and Their Rheological Properties, Macromolecules 37(25): 9465-9472, which are hereby incorporated herein by reference in their respective entireties to the extent they do not conflict with the disclosure presented herein.

In embodiments, the crosslinker comprises an ionic crosslinker.

In embodiments, the crosslinker is an ionic crosslinker as described in U.S. Pat. No. 9,045,615, which is hereby incorporated herein by reference in its entirety to the extent it does not conflict with the disclosure presented herein.

Examples of suitable crosslinkers that may be used include crosslinking monomers; reactive oligomers; polyisocyanate oligomers; functional, crosslinkable polymers; derivatives of ethylene glycol di(meth)acrylate (such as ethylene glycol diacrylate, di(ethylene glycol) diacrylate, tetra(methylene/ethylene glycol) diacrylate, ethylene glycol dimethacrylate (EDMA), di(ethylene glycol) dimethacrylate (DEDMA), tri(methylene/ethylene glycol) dimethacrylate, tetraethylene glycol dimethacrylate (TEDMA)); derivatives of methylenebisacrylamide (such as N,N.-methylenebisacrylamide, N,N.-methylenebisacrylamide, N,N.-(1,2 dihydroxyethylene)bisacrylamide); formaldehyde-free crosslinking agents (such as N-(1-hydroxy-2,2-dimethoxyethyl) acrylamide); divinylbenzene; divinylether; diallyl phthalate; divinylsulfone and the like.

In some embodiments, the crosslinker is an ionic crosslinker comprising a multivalent metal oxide crosslinking agent, such as lead oxide, magnesium oxide, barium oxide, zinc oxide, manganese oxide, copper oxide, aluminum oxide, nickel oxide or combinations thereof. In some embodiments, the ionic crosslinker comprises zinc hydroxide, aluminum hydroxide, magnesium hydroxide, or other metal hydroxides, such as barium hydroxide, manganese hydroxide, copper hydroxide, and nickel hydroxide. In embodiments, an ionic crosslinker comprises a crosslinking monomer, a reactive oligomer, a polyisocyanate oligomer, a functional, crosslinkable polymer, a derivative of ethylene glycol di(meth)acrylate (such as ethylene glycol diacrylate, di(ethylene glycol) diacrylate, tetra(methylene/ethylene glycol) diacrylate, ethylene glycol dimethacrylate (EDMA), di(ethylene glycol) dimethacrylate (DEDMA), tri(methylene/ethylene glycol) dimethacrylate, tetraethylene glycol dimethacrylate (TEDMA)), a derivative of methylenebisacrylamide (such as N,N.-methylenebisacrylamide, N,N.-methylenebisacrylamide, N,N.-(1,2 dihydroxyethylene)bisacrylamide), a formaldehyde-free crosslinking agent (such as N-(1-hydroxy-2,2-dimethoxyethyl) acrylamide), divinylbenzene, divinylether, diallyl phthalate, divinylsulfone and the like. Combinations of these crosslinking agents can also be used.

In some embodiments, the crosslinker is a zinc diacrylate salt. An example of a zinc diacrylate salt is DYMALINK® 9200 ionomeric diacrylate functional monomer available from Total (TotalEnergies) for modification of polyolefins, such as polypropylene.

The blends and layers described herein may comprise any suitable amount of crosslinker. In embodiments, the crosslinker is present in a blend or layer in an amount of 0.1% by weight or greater (“at least 0.1%”), 0.29% by weight or greater, 0.5% by weight or greater, 1% by weight or greater, 1.5% by weight or greater, or 2% by weight or greater. In embodiments, the crosslinker is present in a blend of layer in an amount of 10% by weight, 7.5% by weight or less, or less or 5% by weight. In embodiments, the blend or layer comprises from 0.1% to 6% crosslinker by weight, such as from 0.1% to 5% crosslinker by weight. 0.1% to 4% crosslinker by weight, 0.5% to 6% crosslinker by weight, such as from 0.5% to 5% crosslinker by weight, 0.5% to 4% crosslinker by weight, 1% to 6% crosslinker by weight, 1% to 5% crosslinker by weight, 1% to 4% crosslinker by weight, 1.5% to 6% crosslinker by weight, 1.5% to 5% crosslinker by weight. 1.5% to 4% crosslinker by weight. 2.0% to 6% crosslinker by weight, 2% to 5% crosslinker by weight, 2% to 4% crosslinker by weight, 1% to 2.5% crosslinker by weight, 1.5% to 2% crosslinker by weight, 1% to 3% crosslinker by weight, or the like.

### Films

At least one layer of a film comprises a layer or blend described above. In embodiments, the layer comprises at least 5% tackifier by weight, from 0.1% to 5% by weight crosslinker, and at least 50% by weight polypropylene (PP) of which the layer comprises at least 5% by weight impact PP.

The term “layer,” as used herein, refers to a building block of films that is a structure of a single material type or a homogeneous blend of materials. While the constituents of a layer may be diverse, the composition of a layer is consistent throughout (i.e., the layer is not stratified). Films contain one or more layers that are connected to each other. A layer may contain a single polymer, a blend of materials within a single polymer type (for example, polypropylene) or a blend of various polymer types, may contain metallic materials or other non-polymer materials and may have additives. Layers may be continuous with the film or may be discontinuous or patterned in comparison to the film. A film has two surfaces, opposite each other. The layer at the surface of a film is not connected to another layer of that film at that surface.

The layer or multilayer films comprising the layer are suitable for thermoforming. The layer or multilayer films may be suitable for thermoforming on form/fill/seal lines in which preheating dwell times are short to maintain suitable line speeds. In some embodiments, the layers or films described herein may be suitable for thermoforming with preheat dwell times of ten seconds or less, such as five seconds or less, two seconds or less, one second or less or 0.5 seconds or less. A thermoforming temperature window of about 5 degrees C. may be considered a practical lower limit for being suitable for thermoforming on high-speed form/fill/seal equipment with such preheat dwell times. As described in the Examples below, a polypropylene homopolymer control film had a thermoforming temperature window of about 3 degrees C., which is too low to be practically used for thermoforming on form/fill/seal equipment on a large commercial scale. In some embodiments, the layers or films comprising the layers described herein have a thermoforming temperature window of 5 degrees C. or more, such as 10 degrees C. or more, or 15 degrees C. or more. Such thermoforming temperature windows may permit practical thermoforming on a large commercial scale with short preheating dwell times.

The thermoforming temperature window of a film may be determined by visual inspection of articles thermoformed from the films at various temperatures. The minimum temperature of the thermoformed temperature window may be considered the lowest temperature at which a complete, fully formed, defect free article is formed. The maximum temperature of the thermoforming temperature window may be considered to the temperature at which the thermoformed article begins to melt, deform, or have poor aesthetics.

The layer or multilayer films comprising the layer may have one or more other characteristics suitable for thermoforming. For example, the layer and multilayer films comprising the layer may have suitable sag resistance and other properties, such as, for example, toughness or impact strength for practical use in thermoforming. Layers and films comprising sufficiently large elongational viscosities may have sufficient sag resistance for practical use in thermoforming. In embodiments, the layers and films have an elongational viscosity of 500,000 Pa s or greater in the machine direction, such as 600,000 Pas or greater, 700,000 Pa s or greater, 800,000 Pa s or greater, 900,000 Pa s or greater, or 1,000,000 Pa s or greater in the machine direction. In embodiments, the layers and films have an elongational viscosity of 500,000 Pas or greater in the transverse direction, such as 600,000 Pa s or greater, 700,000 Pa s or greater, 800,000 Pa s or greater, 900,000 Pa s or greater, or 1,000,000 Pa s or greater in the transverse direction. The layers and films have an elongational viscosity of 500,000 Pa s or greater in both the machine direction and the transverse direction, such as 600,000 Pa s or greater, 700,000 Pa s or greater, 800,000 Pa s or greater, 900,000 Pa s or greater, or 1,000,000 Pa s or greater in both the machine direction and the transverse direction. Elongational viscosity may be measured using a TA Instruments Discovery Hybrid Rheometer (DHR)-2 outfitted with a SER3 universal testing platform.

Elongational viscosity may be measured as follows. Samples may be compression molded from pellets into 2 mm thick films. The pellets may be melted at 210° C. for 5 minutes with the mold resting in contact with both the top and bottom platens. Then, 20,000 lbs of pressure may be applied for 2 minutes. The sample may be removed and placed in a 23° C. press with 10,000 lbs of pressure to cool. Then the sample may be removed from the mold and conditioned for 24 hours at 23° C. with 50% humidity before measuring elongational viscosity. Sample strips measuring 4 mm by 12 mm may be cut into compression molded 2 mm thick films. These may each be loaded into a TA Instruments DHR-2 hybrid rheometer with a SER3 universal testing platform attachment. The sample may receive a temperature soak of 170° C. for 300 seconds, and then an extensional rate of 0.1 s⁻¹ at 170° C. may be applied until a final strain of 4.0 is reached. The peak elongational viscosity measured according to this method may be reported as the elongational viscosity value. The method and apparatus (Sentmanat Extension Rheometer) for measuring the elongational viscosity are also described in U.S. Pat. Nos. 6,578,413 and 6,691,569, the contents of which are hereby incorporated herein by reference in their respective entireties to the extent that they do not conflict with the disclosure presented herein.

The films comprising a layer described herein may comprise any suitable number of layers. In some embodiments, the film consists of, or consists essentially of, a single layer. In embodiments, the film has 2, 3, 4, 5, 6, 7, 8, 9, 10, 11 or more layers. In some embodiments, the film has at least three layers.

When the film comprises more than one layer, the layer comprising at least 50% by weight PP (including impact PP), the tackifier, and the crosslinker is preferably an interior layer. As used herein, an “interior” layer of a film is a layer that is between two other layers of the film. In some embodiments, layers other than the interior layer are thinner than the interior layer. The interior layer may have adequate stretching behavior to compensate for deficiencies in other layers (e.g., layers comprising PP but no tackifier or crosslinker). By keeping the other layers thinner, heat may more readily penetrate to the interior layer during thermoforming. In embodiments, the surface layers (or exterior layers) of the film are each about 10% to about 15% of the overall thickness of the film. In some embodiments the film comprises an interior layer comprising the PP/tackifier/crosslinker blend and an exterior layer on either side of the interior layer, each exterior layer having a thickness that is less than 15% of the overall thickness of the film.

The films described herein may be fully coextruded or may be produced by other processes such as lamination or coating. Overall, the films described herein may have any suitable thickness. In embodiments, the films may have a thickness from about 4 mil (102 micron) to about 80 mil (2,032 micron), thicknesses which may be suitable for thermoforming. Some packaging applications would benefit from a thermoformable base film that has a thickness from about 8 mil (203 micron) to about 50 mil (1,270 micron). In some embodiments, the film has a thickness from about 8 mil (203 micron) to about 25 mil (635 micron).

The films comprising a layer as described herein are preferably suitable for recycling. To be suitable for recycling, the total composition of the film should be suitable for recycling. In embodiments, the film has a total composition suitable for recycling in a process that typically accepts polypropylene-based materials. Some recycling streams that accept PP-based materials may accept mixed polyolefin-based material, such as PP-based and polyethylene-based materials.

The films described herein may be recycled after their primary use is completed. As used herein, the term “suitable for recycling” is meant to indicate that the film can be converted into a new useful item, by means of reprocessing in a polyolefin recycle stream (e.g., recycling streams based on PP). Reprocessing may entail washing, separating, melting and forming, among many other steps. Typically, when plastic packaging is recycled by reprocessing, the material is mechanically chopped into small pieces, melted, mixed and reformed into the new product. If multiple incompatible materials are present in the packaging, interactions occur during reprocessing causing gels, brittle material, poor appearance and generally unusable or poor-quality products. Using the term “recyclable” indicates that these drawbacks are generally not present. Qualification as a recyclable material is not regulated by any specific agencies but can be obtained from specific groups such as Association of Plastic Recyclers (APR) and How2Recycle™. Recyclable films disclosed herein may be suitable for PP-based recycling streams. Introduction of a recyclable film into any of these recycling-by-reprocessing avenues may, in some embodiments, not require additional compatibilizer.

Being suitable for recycling may be obtained by keeping the overall amount of PP in the total composition of the film at a high level. Any additives used should be kept to a minimum. Any non-PP-based polymers present may be accompanied by compatibilizers to achieve a composition suitable for recycling.

In some embodiments, the films described herein include 50% or more (“at least 50%”) by weight PP, such as at least 60% by weight PP, at least 70% by weight PP, at least 80% by weight PP, or at least 90% by weight PP.

To further efforts to achieve a total composition that is suitable for recycling, some embodiments of the film are free from, or essentially free from, polyester materials. Polyester materials are typically used in films because of thermoforming ease, stiffness and clarity. However, the presence of polyester may greatly hinder the recyclability of the film. In some embodiments, the film comprises less than 20% by weight polyester, such as less than 10% by weight polyester, less than 5% by weight polyester, or less than 1% by weight polyester.

To further efforts to achieve a total composition that is suitable for recycling, some embodiments of the film are free from, or essentially free from, EVOH materials. EVOH is typically used in films because it is a thermoformable oxygen barrier material. However, the presence of EVOH may greatly hinder the recyclability of the film. In some embodiments, the film comprises less than 10% by weight EVOH, less than 5% by weight EVOH, or less than 1% by weight EVOH.

To further efforts to achieve a total composition that is suitable for recycling, some embodiments of the thermoformable base film are free from, or essentially free from, polyamide materials. Polyamide materials are typically used because of thermoforming ease, durability and stiffness. However, the presence of polyamide may greatly hinder the recyclability of the film. In some embodiments, the film comprises less than 20% by weight polyamide, such as less than 10% by weight polyamide, less than 5% by weight polyamide, or less than 1% by weight polyamide.

The thermoformable base film may be free from polyester, EVOH and polyamide. In some embodiments, the film comprises less than 20% by weight polyester, EVOH and polyamide, cumulatively, such as less than 10% by weight polyester, EVOH and polyamide, cumulatively, less than 5% by weight polyester, EVOH and polyamide, cumulatively, or less than 1% by weight polyester, EVOH and polyamide, cumulatively.

In some embodiments, the film comprises one or more oxygen barrier layers. In embodiments, the oxygen barrier layer is an interior layer of the film. The oxygen barrier layer contains a material that is known to limit the transmission of oxygen through the film. One choice for an oxygen barrier material is EVOH. In some cases, EVOH may be present along with a compatibilizer that allows EVOH to be incorporated into the PP recycling stream.

As used herein, “EVOH” refers to ethylene vinyl alcohol copolymer. EVOH is otherwise known as saponified or hydrolyzed ethylene vinyl acetate copolymer and refers to a vinyl alcohol copolymer having an ethylene comonomer. EVOH is prepared by the hydrolysis (or saponification) of an ethylene-vinyl acetate copolymer. EVOH is commercially available in resin form with various percentages of ethylene. Preferably, ethylene/vinyl alcohol copolymers comprise from about 27-38 mole % ethylene, or even 27-29 mole % ethylene.

The film may comprise one or more tie layers. Tie layers bond dissimilar layers. For example, a tie layer may be used to bond an EVOH layer to a PP layer. The need for tie layers is dependent upon the materials in the adjacent layers. Tie layers based on PP copolymers are typically suitable for films described herein.

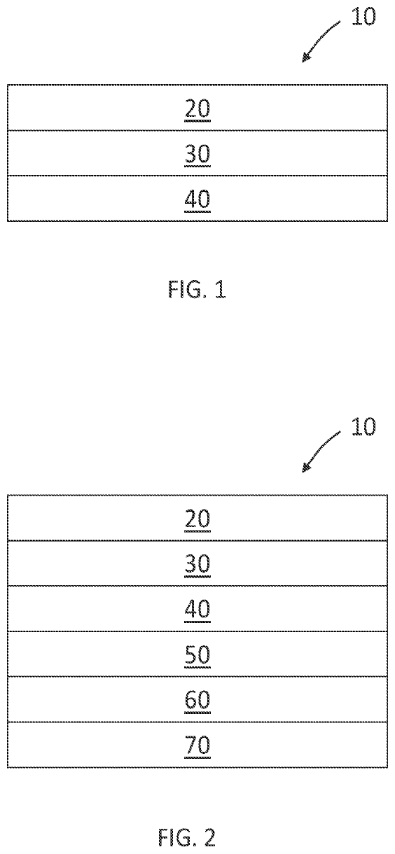

In some embodiments, and with reference to FIG. 1, the film 10 comprises three layers: a first layer 20, a second layer 30, and a third layer 40. The second layer 30 is between the first 20 and the third 40 layers. The second layer 30 may comprise at least 5% tackifier by weight, from 0.1% to 5% by weight crosslinker, and at least 50% by weight polypropylene (PP) of which the layer comprises at least 5% by weight impact PP. In some embodiments, the first 20 and the third 40 layers are PP layers. The first 20 and third 40 layers may comprise 50% or more by weight PP, 60% or more by weight PP, 70% or more by weight PP, 80% or more by weight PP, 90% or more by weight PP, or 95% or more by weight PP. In some embodiments, the first 20 and third 40 layers consist of, or consist essentially of, PP. The first 20 and third 40 layers may be the same or different. In some embodiments, the first 20 and third 40 layers are the same compositionally.

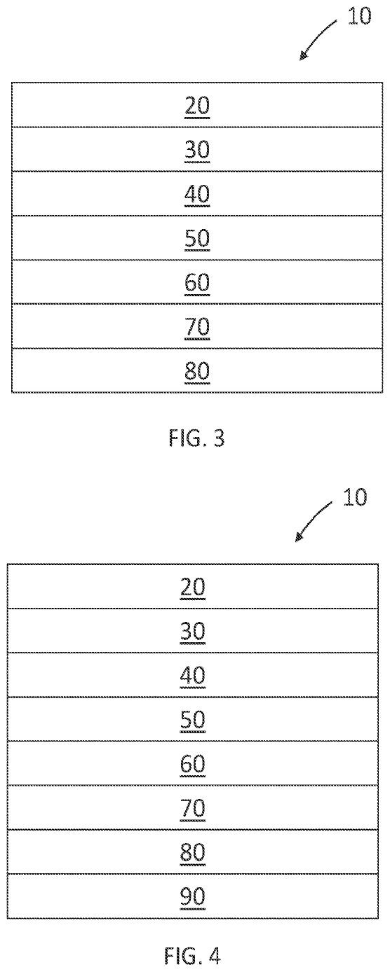

In some embodiments, and with reference to FIG. 2, the film 10 comprises six layers. The second layer 30 may comprise at least 5% tackifier by weight, from 0.1% to 5% by weight crosslinker, and at least 50% by weight polypropylene (PP) of which the layer comprises at least 5% by weight impact PP. In some embodiments, the first layer 20 and the sixth layer 70 are PP layers. The first 20 and sixth 70 layers may comprise 50% or more by weight PP, 60% or more by weight PP, 70% or more by weight PP, 80% or more by weight PP, 90% or more by weight PP, or 95% or more by weight PP. In some embodiments, the first 20 and sixth 70 layers consist of, or consist essentially of, PP. The first 20 and sixth 70 layers may be the same or different. In some embodiments, the first 20 and sixth 70 layers are the same compositionally.

Still with reference to FIG. 2, the fourth layer 50 may be a barrier layer. In some embodiments, the fourth 50 layer is an EVOH layer. The third 40 and fifth 60 layers may be tie layers. The tie layers may be PP copolymer layers. The third 40 and fifth 60 layers may be the same or different. In some embodiments, the third 40 and fifth 60 layers are the same.

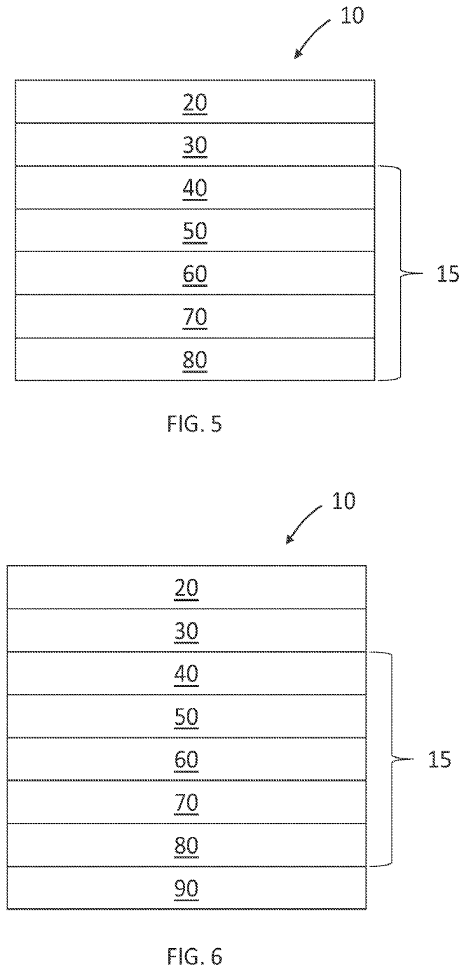

In some embodiments, and with reference to FIG. 3, the film 10 comprises seven layers. The second 30 and sixth 70 layers may comprise at least 5% tackifier by weight, from 0.1% to 5% by weight crosslinker, and at least 50% by weight polypropylene (PP) of which the layers comprise at least 5% by weight impact PP. The second 30 and sixth 70 layers may be the same or different. In some embodiments, the second 30 and sixth 70 layers are the same. In some embodiments, the first layer 20 and the seventh layer 80 are PP layers. The first 20 and seventh 80 layers may comprise 50% or more by weight PP, 60% or more by weight PP, 70% or more by weight PP, 80% or more by weight PP, 90% or more by weight PP, or 95% or more by weight PP. In some embodiments, the first 20 and seventh 80 layers consist of, or consist essentially of, PP. The first 20 and seventh 80 layers may be the same or different. In some embodiments, the first 20 and seventh 80 layers are the same compositionally.

Still with reference to FIG. 3, the fourth layer 50 may be a barrier layer. In some embodiments, the fourth 50 layer is an EVOH layer. The third 40 and fifth 60 layers may be tie layers. The tie layers may be PP copolymer layers. The third 40 and fifth 60 layers may be the same or different. In some embodiments, the third 40 and fifth 60 layers are the same compositionally.

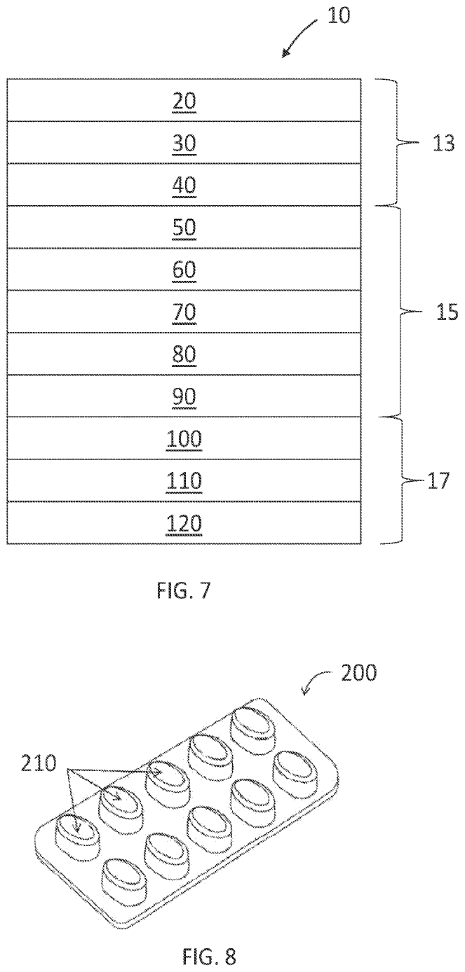

In some embodiments, and with reference to FIG. 4, the film 10 comprises eight layers. The second 30 and sixth 70 layers may comprise at least 5% tackifier by weight, from 0.1% to 5% by weight crosslinker, and at least 50% by weight polypropylene (PP) of which the layers comprise at least 5% by weight impact PP. The second 30 and sixth 70 layers may be the same or different. In some embodiments, the second 30 and sixth 70 layers are the same. In some embodiments, the first layer 20 is a PP layer. The first layer 20 may comprise 50% or more by weight PP, 60% or more by weight PP, 70% or more by weight PP, 80% or more by weight PP, 90% or more by weight PP, or 95% or more by weight PP.

Still with reference to FIG. 4, the fourth layer 50 may be a barrier layer. In some embodiments, the fourth 50 layer is an EVOH layer. The third 40 and fifth 60 and seventh 80 layers may be tie layers. The tie layers may be PP copolymer layers. The third 40 and fifth 60 and seventh 80 layers may be the same or different. In some embodiments, the third 40 and fifth 60 and seventh 80 layers are the same. The eighth layer 90 may be a seal layer. The seal layer may be a polyethylene layer. The film 10 may comprise any suitable polypropylene or polyethylene seal layer. Examples of suitable polymers for a polyethylene seal layer include polyethylene homopolymers, such as low density polyethylene; ethylene α-olefin copolymers, such as linear low density polyethylene; ethylene vinyl acetate copolymers; ethylene alkyl acrylate copolymers, such as ethylene methyl acrylate copolymer; copolymers of ethylene and ethylenically unsaturated carboxylic acids, such as ethylene acrylic acid copolymer and ethylene methacrylic acid copolymer, ionomers, and combinations thereof.

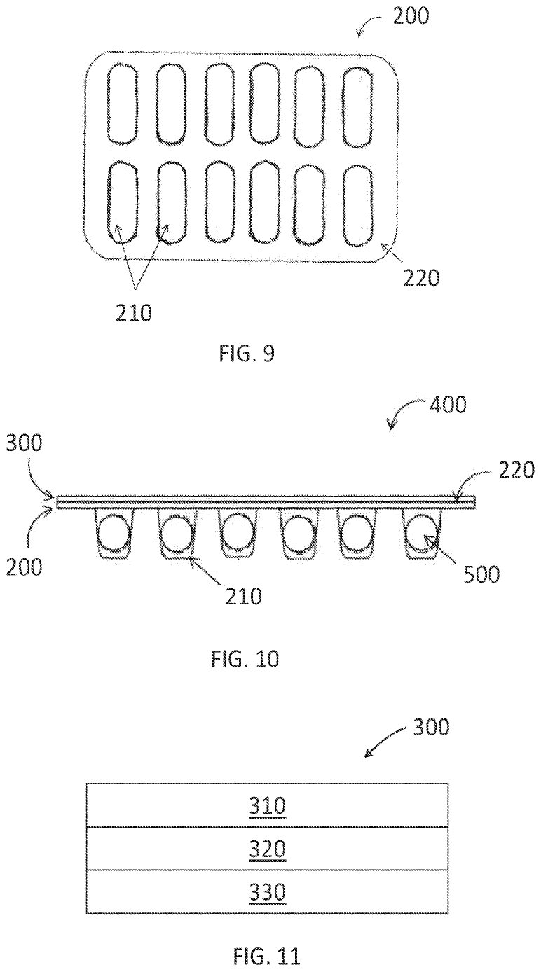

In some embodiments, and with reference to FIG. 5, the film 10 comprises seven layers. The second layer 30 may comprise at least 5% tackifier by weight, from 0.1% to 5% by weight crosslinker, and at least 50% by weight polypropylene (PP) of which the layer comprises at least 5% by weight impact PP. In some embodiments, the first layer 20, the third layer 40, and the seventh layer 80 are PP layers. The first 20, third 40, and seventh 80 layers may be the same or different. In embodiments, the first 20, third 40, and seventh 80 layers are the same. In embodiments, the third 40 and seventh 80 layers are the same. The first layer 20, the third layer 40, and the seventh layer 80 may comprise 50% or more by weight PP, 60% or more by weight PP, 70% or more by weight PP, 80% or more by weight PP, 90% or more by weight PP, or 95% or more by weight PP. In embodiments, the first layer 20, the third layer 40, and the seventh layer 80 consist of, or consist essentially of, PP. The fifth layer 60 may be an EVOH layer. The fourth 50 and sixth 70 layers may be tie layers. The tie layers may be PP copolymer layers. The fourth 50 and sixth 70 layers may be the same or different. In some embodiments, the fourth 50 and sixth 70 layers are the same.

In some embodiments, the third 40 through seventh 80 layers of the film 10 depicted in FIG. 5 may comprise a blown film 15. The blown film 15 may be made in any suitable manner. For example, the blown film 15 may be made by a standard blown film coextrusion process, collapsing the bubble into a single palindromic film. A film comprising the first 20 and second 30 layers may be coated onto the blown film 15 to produce the final film 10.

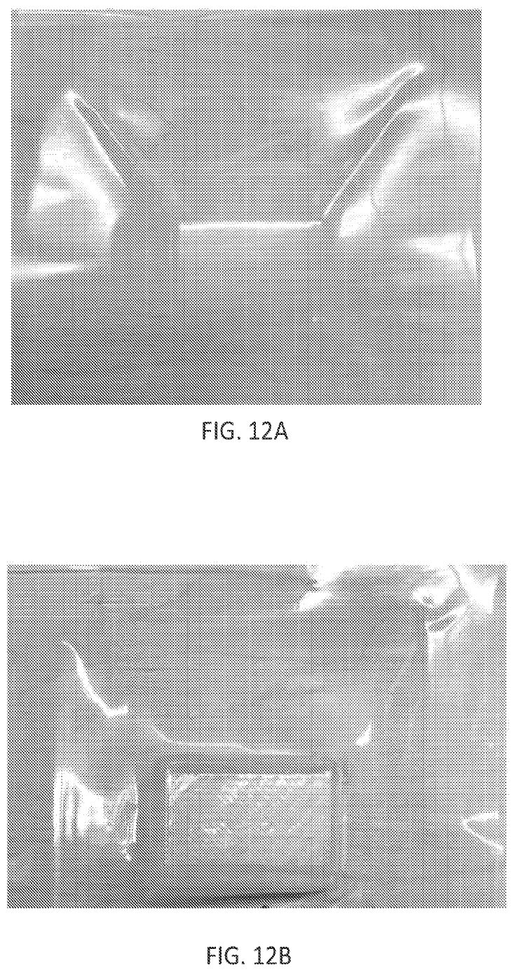

In some embodiments, and with reference to FIG. 6, the film 10 comprises eight layers. In embodiments, first 20, second 30, third 40, fourth 50, fifth 60, sixth 70, and seventh 80 layers are the same as depicted in, and discussed regarding, FIG. 5. In some embodiments depicted in FIG. 6, the eighth layer 90 is a PP layer. The eighth layer 90 may be the same or different than the first 20 layer. In embodiments, the eighth layer 90 is the same as the first layer 20. The eighth layer 90 may be coated on the blown film 15.

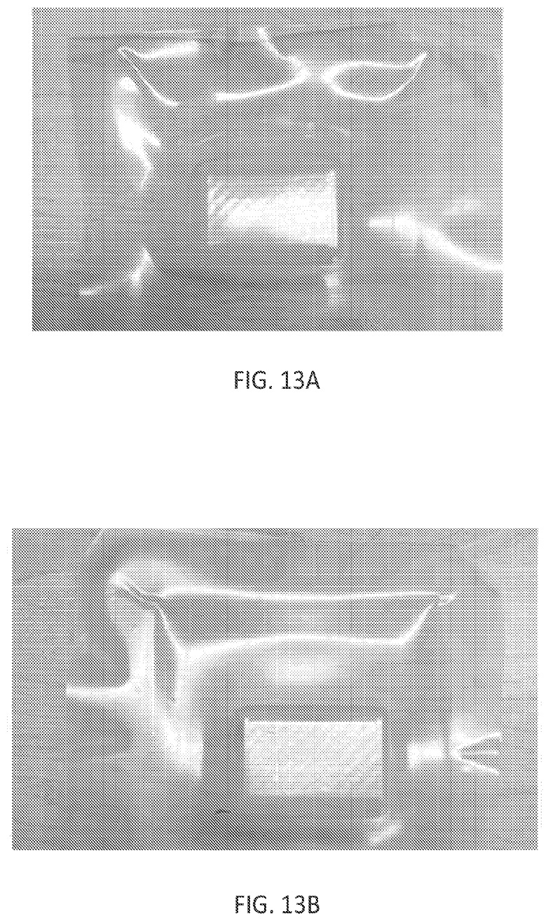

In some embodiments, and with reference to FIG. 7, the film 10 comprises eleven layers. In some embodiments, the film 10 is made by forming a blown film 15 and coating films 13 and 17 onto the blown film 15. Film 13 and film 17 may be the same or different. In embodiments, film 13 and film 17 are the same. For example, second layer 30 and the tenth layer 110 may comprise at least 5% tackifier by weight, from 0.1% to 5% by weight crosslinker, and at least 50% by weight polypropylene (PP) of which the layer comprises at least 5% by weight impact PP. In some embodiments, the first 20 and the third 40 layers, and the ninth 100 and eleventh 120 layers, are PP layers. The first 20, third 40, ninth 100, and eleventh 120 layers may comprise 50% or more by weight PP, 60% or more by weight PP, 70% or more by weight PP, 80% or more by weight PP, 90% or more by weight PP, or 95% or more by weight PP. In some embodiments, the first 20, third 40, ninth 100, and eleventh 120 layers consist of, or consist essentially of, PP. The first 20 and third 40 layers, and the ninth 100 and eleventh 120 layers, may be the same or different. In some embodiments, the first 20 and third 40 layers are the same, and the ninth 100 and eleventh 120 layers are the same.

In some embodiments, the fourth 50 through eighth 90 layers of the film 10 depicted in FIG. 5 may comprise a blown film 15. The blown film 15 may be made in any suitable manner. For example, the blown film 15 may be made by a standard blown film coextrusion process, collapsing the bubble into a single palindromic film. For example, the sixth layer 70 may be an EVOH layer, the fifth 60 and seventh 80 layers may be tie layers, which may be PP copolymer layers, and the fourth 50 and eighth 90 layers may be PP layers.

It will be understood that the films 10 depicted in FIGS. 1-7 are just a few of the many possible films that may contain a layer comprising at least 5% tackifier by weight, from 0.1% to 5% by weight crosslinker, and at least 50% by weight polypropylene (PP) of which the layer comprises at least 5% by weight impact PP. The films 10 depicted in, and discussed regarding, FIGS. 1-7, as well as many others, may be used as a base film for thermoforming articles, such as packaging components.

### Thermoformed Packaging Components and Packaged Products

The films described herein having a layer comprising at least 5% tackifier by weight, from 0.1% to 5% by weight crosslinker, and at least 50% by weight polypropylene (PP), of which the layer comprises at least 5% by weight impact PP, may be a thermoformable base film suitable for packaging products. A lidding film may be heat sealed to a thermoformed base packaging component made from the thermoformable base film, creating a package that may be accepted in a recycling process. The packaging may be suitable for products such as, but not limited to, pharmaceuticals, nutraceuticals, medical products, fresh foods, refrigerated foods, shelf-stable foods, consumer goods, cosmetics and chemicals.

The packages described herein, may incorporate at least two packaging components. First is a thermoformed base component, made from a PP-based film. The thermoformed cavity may be deep or shallow and is generally shaped to hold the intended product therein. The thermoformable base film should be of a thickness to provide for the desired rigidity (i.e. stiffness), durability and barrier upon thermoforming. Second is a lid packaging component. The lid is configured from a film that is capable of being hermetically heat sealed to the thermoformed base component, producing a protective package for the product.

In some embodiments of the package, a lid component having a composition high in PP may be used in conjunction with the thermoformed base. The combination of the thermoformed base component and the lid packaging component may provide a highly homogeneous polymer composition (mostly comprising PP) to provide for the opportunity to recycle the entire package in a single stream.

The packaging components described herein are unique in that they are produced using high levels of PP yet retain high-performance characteristics required for demanding thermoformed packaging applications. The hermetically sealed packages may provide excellent product protection, good appearance, good forming accuracy and consistency, good heat resistance, and good seal strength. Packages with these levels of performance have not previously been delivered using materials that can be easily recycled in the PP recycling stream.

The thermoformable base films may be formed into packaging components (thermoformed bases) and used in conjunction with other packaging components (such as lidding) to produce packaging. Thermoformed bases may be produced from the thermoformable base film by a thermoforming process using heat and pressure (mechanical and/or vacuum). The thermoformed base may be highly rigid and inflexible, or the thermoformed base may be flexible while still maintaining the thermoformed shape. The thermoformed bases described herein have at least one cavity to hold a product and a flange at least partially surrounding each of the cavities. The flange is generally an unformed area of the film and serves as a place to connect the thermoformed base to the other packaging components, which may be a lid, another thermoformed base component or some other packaging component. The flange may comprise a hinge or may be located adjacent to a hinge where the hinge facilitates formation of a clamshell style package.

The thermoformable base films may be particularly well suited for thermoformed components that have a depth of draw ratio of 1:2 or greater (i.e., such as 1:1 or 2:1). The depth of draw ratio is defined as the ratio of the maximum depth of the thermoformed cavity and the minimum distance across the open face of the thermoformed cavity. As the depth of draw ratio increases, a deeper cavity is being formed from a smaller area of film. A thermoformed article having a depth of draw ratio of 1:2 or greater may be significantly easier to form from the thermoformable films disclosed herein because of the wider forming window.

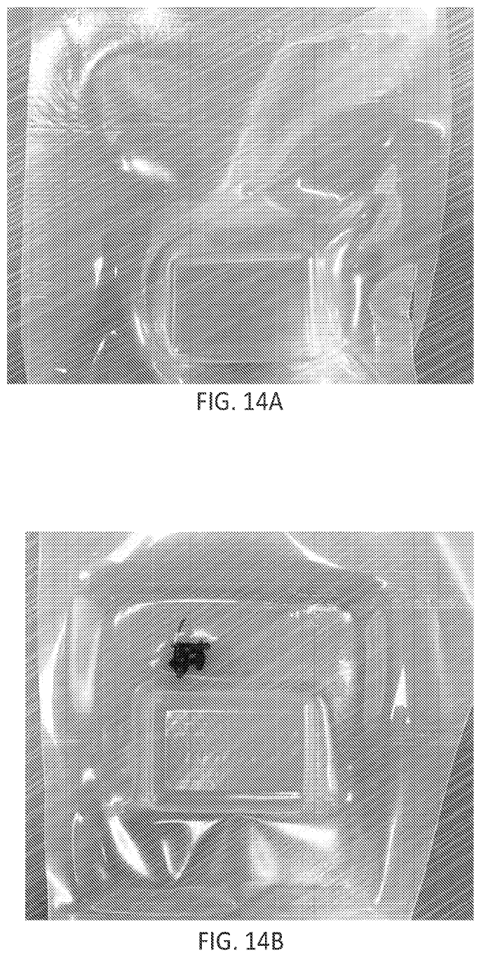

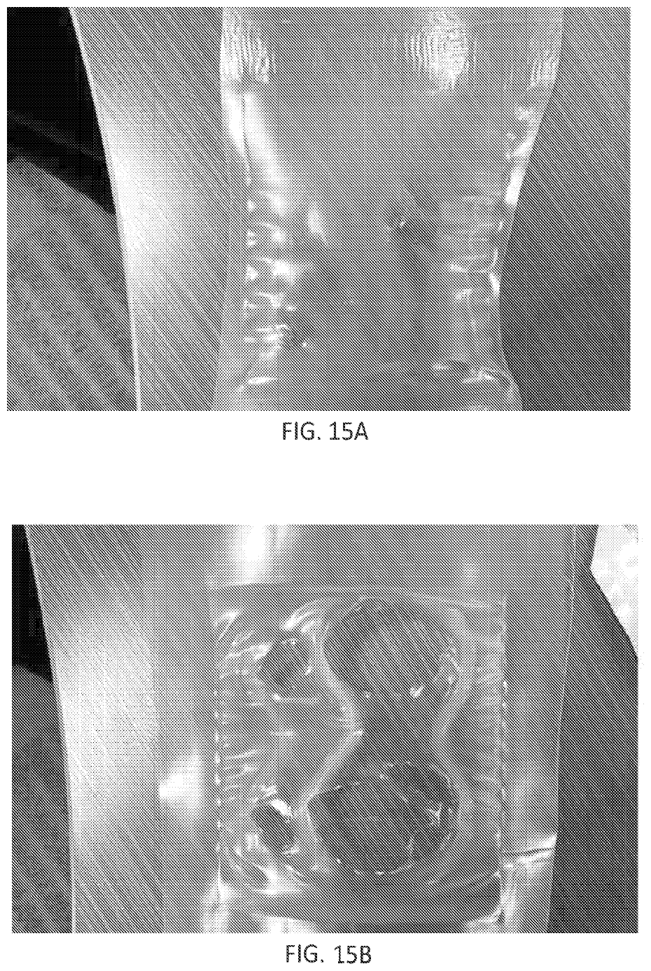

Examples of thermoformed bases are shown in FIGS. 8-10. In the embodiments depicted in FIGS. 8-10, the thermoformed bases 200 have multiple (10 or 12) small cavities 210 surrounded by a flange 220. Cavities such as these may be sized specifically to hold an individual pharmaceutical tablet or capsule. Alternatively, the cavity of the thermoformed base may be large and hold multiple product pieces. Cavities of all numbers, sizes and shapes are anticipated by this disclosure.

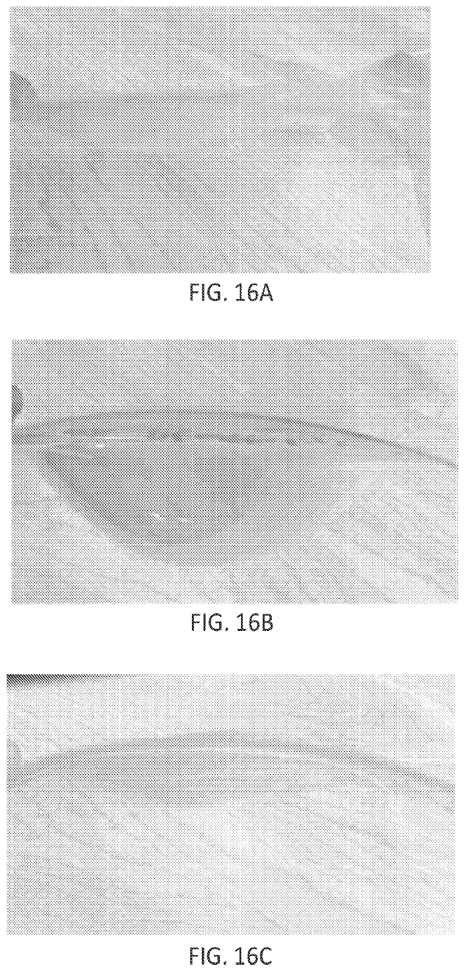

Each cavity 210 present is surrounded by a flange 220, as shown in the packaged product embodiment of FIG. 10. The flange 220 of the thermoformed base 200 should be an area without curvature for attachment to another packaging component, such as a lid packaging component 300. There is a product 500 enclosed in each of the cavities. The lid 300 component may be hermetically sealed to the flange 220 in areas surrounding each of the cavities 210 of the thermoformed base 200. Alternatively, the lidding 300 may be connected to the thermoformed base 200 at the flange 220 in an area including the entire perimeter surrounding all the cavities 210, and not between each of the cavities 210.

The thermoformed base may be attached to another packaging component by way of a seal, preferably a hermetic seal. In this manner, the product inside the package is completely enclosed in the cavity and protected by way of the thermoformed base and the other packaging component(s). The exchange of gasses, liquids, microbes or other materials is limited to those that are able to pass through the packaging components, as the hermetic seal does not permit passage in the space between the components.

The product that is contained in the cavities of the thermoformed base is not limited. The product may be sensitive to the environment such as pharmaceuticals or foods. The product may require physical protection, such as delicate medical devices. The product may need to be contained for consumer protection, such as medicaments or cleaners that should be in child proof packaging. The product may be suitable for easy dispensing such as gum or candy.

If a lid packaging component is included in the packaged product, the lid may be of any composition that is suitable for the application. The lid should have a heat sealable exterior layer that is formulated such that it can be readily attached to the thermoformed base by way of heat sealing. The seal between the lid packaging component and the thermoformed base may be peelable (i.e. readily separated manually, with peel strength less than about 2,500 g/in) or fusion.

If the lid is fusion sealed to the thermoformed base, the lid may be formulated and/or designed such that the product can be pushed through the lid for dispensing. Particularly for applications of a packaged product that include pharmaceutical tablets, gum pieces or the like, the cavities of the thermoformed base may be flexible enough that a consumer can depress the cavity manually, forcing the product through the lid component, for dispensing.

The lid packaging component may have a moisture and/or oxygen barrier that is similar in performance to the thermoformed base. Materials that are commonly used in high-performance lidding include but are not limited to metal layers or paper layers. The metal and/or paper layers may be laminated or otherwise connected to polymer layers including a heat sealing layer. The lid may be printed, scored or otherwise modified for specific properties.

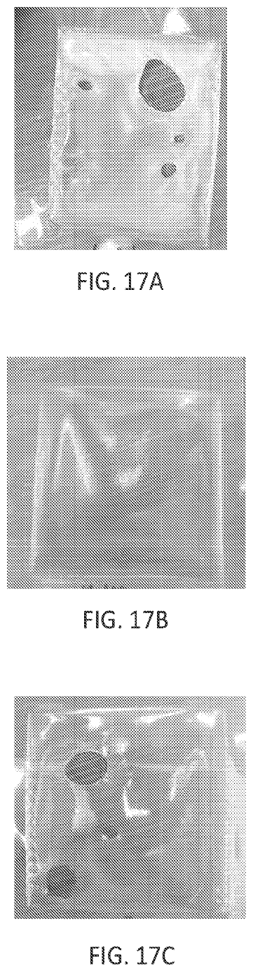

One example of a lid component that may be sealed to a thermoformed base to provide a packaged product is shown in FIG. 11. The lid 300 may have a first exterior layer 310 containing polypropylene and an inorganic particle, such as talc or calcium carbonate. This type of exterior layer 310 provides high heat resistance during the process of sealing the lid component to the thermoformed base component to enclose the product. The lid 300 may have a second exterior layer 330 that has a polypropylene-base material, formulated to heat seal to the thermoformed base at relatively low temperatures. The lid 300 may have a first interior layer 320. The interior layer may comprise at least 50% by weight polypropylene (PP).

One advantage to the lid 300 as shown in FIG. 11 is that it would have similar recyclability as compared to the thermoformable base films described herein, such that the entire package could be recycled together without separating. Other examples of packages include a thermoformed base as described herein and a lid, and the lid is attached to the thermoformed base by a peelable seal.

### Certain Definitions

As used herein, singular forms “a,” “an” and “the” include plural referents unless the context clearly dictates otherwise. Thus, for example, reference to a “structured bottom surface” includes examples having two or more such “structured bottom surfaces” unless the context clearly indicates otherwise.

As used herein, the term “or” is generally employed in its sense including “and/or” unless the content clearly dictates otherwise. The term “and/or” means one or all the listed elements or a combination of any two or more of the listed elements. The use of “and/or” in certain instances herein does not imply that the use of “or” in other instances does not mean “and/or”.

As used herein, “have”, “has”, “having”, “include”, “includes”, “including”, “comprise”, “comprises”, “comprising” or the like are used in their open-ended inclusive sense, and generally mean “include, but not limited to”, “includes, but not limited to”, or “including, but not limited to”.

“Optional” or “optionally” means that the subsequently described event, circumstance, or component, can or cannot occur, and that the description includes instances where the event, circumstance, or component, occurs and instances where it does not.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

For purposes of the present disclosure, recitations of numerical ranges by endpoints include all numbers subsumed within that range (e.g., 1 to 5 includes 1, 1.5, 2, 2.75, 3, 3.80, 4, 5, etc.). Where a range of values is “greater than”, “less than”, etc. a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

As used herein, “providing” an article, such as a film, means to make, purchase, or otherwise obtain the article.

The term “layer” refers to a discrete component of a film that has a substantially uniform composition. A layer may or may not be coextensive with the film.

As used herein, a “polymer” refers to a material that is the product of polymerization or copolymerization of natural, synthetic or combined natural and synthetic monomers or co-monomers, or monomers and co-monomers, and is inclusive of homopolymers, copolymers, terpolymers, and the like. A layer may comprise a single polymer, a mixture of a polymer and non-polymeric material, a combination of two or more polymers blended together, or a mixture of two or more polymers and non-polymeric material.

A “polyolefin,” “polyethylene,” “polypropylene,” or “EVOH” are inclusive of not only polymers comprising repeating units derived from monomers known to polymerize to form a polymer of the named type, but are also inclusive of comonomers, as well as both unmodified and modified polymers made by e.g. derivatization of a polymer after its polymerization to add functional groups or moieties along the polymeric chain. Furthermore, terms identifying polymers are also inclusive of “blends” of such polymers.

Percentages of components in a blend or layer described herein are expressed in percent by weight unless otherwise specified.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

Reference in the specification to “some embodiments,” “an embodiment,” “one embodiment,” “one or more embodiments,” “embodiments,” “other embodiments,” or the like means that a particular feature, structure, or characteristic described in connection with the embodiments is included in at least one or more embodiments, but not necessarily all embodiments, of the present disclosure.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a film comprising polypropylene, tie, and EVOH layers include embodiments where the film consists of a polypropylene, tie, and EVOH layers and embodiments the film consists essentially of polypropylene, tie, and EVOH layers.

### Selected Embodiments

A number of embodiments of recyclable packaging film and methods have been described herein. A non-exhaustive list of non-limiting embodiments are listed below. Any one or more of the features of these embodiments may be combined with any one or more features of another embodiments or aspect described herein.

Embodiment Ex1: A thermoformable polymeric film comprising a polymeric layer, the polymeric layer comprising: (i) at least 50% polypropylene by weight, wherein the polypropylene comprises impact polypropylene and wherein the layer comprises at least 5% impact polypropylene by weight; (ii) at least 5% tackifier by weight; and (iii) from 0.1% to 5% crosslinker by weight, such as from 0.5% to 5% crosslinker by weight.

Embodiment Ex2: The film of Embodiment Ex1, wherein the polymeric layer comprises from 1% to 3% of the crosslinker by weight.

Embodiment Ex3: The film of Embodiment Ex1, wherein the polymeric layer comprises from 1.5% to 2.5% of the crosslinker by weight.

Embodiment Ex4: The film of any one of Embodiments Ex1 to Ex3, wherein the crosslinker comprises an ionic crosslinker.

Embodiment Ex5: The film of any one of Embodiments Ex1 to Ex4, wherein the polymeric layer comprises from 5% to 40% tackifier by weight.

Embodiment Ex6: The film of any one of Embodiments Ex1 to Ex4, wherein the polymeric layer comprises from 10% to 25% tackifier by weight.

Embodiment Ex7: The film of any one of Embodiments Ex1 to Ex4, wherein the polymeric layer comprises from 15% to 20% tackifier by weight.

Embodiment Ex8: The film of any one of Embodiments Ex1 to Ex7, wherein the polymeric layer comprises from 5% to 50% impact polypropylene by weight, such as 10% to 30% impact polypropylene by weight.

Embodiment Ex9: The film of any one of Embodiments Ex1 to Ex7, wherein the polymeric layer comprises from 10% to 25% impact polypropylene by weight.

Embodiment Ex10: The film of any one of Embodiments Ex1 to Ex9, wherein the polymeric layer comprises at least 60% polypropylene by weight.

Embodiment Ex11: The film of any one of Embodiments Ex1 to Ex9, wherein the polymeric layer comprises at least 70% polypropylene by weight.

Embodiment Ex12: The film of any one of Embodiments Ex1 to Ex9, wherein the polymeric layer comprises at least 80% polypropylene by weight.

Embodiment Ex13: The film of any one of Embodiments Ex1 to Ex12, wherein the film consists of or consists essentially of the polymeric layer.

Embodiment Ex14: The film of Embodiment Ex13, further comprising a second layer comprising polypropylene.

Embodiment Ex15: The film of Embodiment Ex14, wherein the second layer comprises at least 80% polypropylene by weight.

Embodiment Ex16: The film of Embodiment Ex14 or Ex15, further comprising a third layer comprising polypropylene.

Embodiment Ex17: The film of Embodiment Ex16, wherein the third layer comprises at least 80% polypropylene by weight.

Embodiment Ex18: The film of Embodiment Ex16 or claim Ex17, wherein the polymeric layer is between the second layer and the third layer.

Embodiment Ex19: The film of any one of Embodiments Ex1 to Ex18, wherein the film has a thermoform temperature window of 5 degrees Celsius or greater.

Embodiment Ex20: The film of any one of Embodiments Ex1 to Ex18, wherein the film has a thermoform temperature window of 10 degrees Celsius or greater.

Embodiment Ex21: The film of any one of Embodiments Ex1 to Ex18, wherein the film has a thermoform temperature window of 15 degrees Celsius or greater.

Embodiment Ex22: A package comprising the film of any one of Embodiments Ex1 to 21.

Embodiment Ex23: A packaged product comprising the package of Embodiment Ex22 and a product within the package.

Embodiment Ex24: A thermoformed article comprising the film of any one of Embodiments Ex1 to Ex21.

Embodiment Ex25: The article of Embodiment Ex24, wherein the thermoformed article has a depth of draw ratio (maximum depth of the formed cavity/minimum distance across the formed cavity opening) of 1:2 or greater, such as about 1:1.

Embodiment Ex26: A method for forming a thermoformable film layer, the method comprising: (i) blending polypropylene matrix polymer, an impact polypropylene polymer, a tackifier, and a crosslinker; and (ii) forming the film layer from the blend, wherein the film layer comprises: (a) at least 50% polypropylene by weight, wherein the polypropylene comprises impact polypropylene and wherein the layer comprises at least 5% impact polypropylene by weight; (b) at least 5% tackifier by weight; and (c) from 0.1% to 5% crosslinker by weight, such as from 0.5% to 5% crosslinker by weight.

Embodiment Ex27: The method of Embodiment Ex26, wherein the polymeric layer comprises from 1% to 3% of the crosslinker by weight.

Embodiment Ex28: The method of Embodiment Ex26, wherein the polymeric layer comprises from 1.5% to 2.5% of the crosslinker by weight.

Embodiment Ex29: The method of any one of Embodiments Ex26 to Ex28, wherein the crosslinker comprises an ionic crosslinker.

Embodiment Ex30: The method of any one of Embodiments Ex26 to Ex29, wherein the polymeric layer comprises from 5% to 40% tackifier by weight.

Embodiment Ex31: The method of any one of Embodiments Ex26 to Ex29, wherein the polymeric layer comprises from 10% to 25% tackifier by weight.

Embodiment Ex32: The method of any one of Embodiments Ex26 to Ex29, wherein the polymeric layer comprises from 15% to 20% tackifier by weight.

Embodiment Ex33: The method of any one of Embodiment Ex26 to Ex32, wherein the polymeric layer comprises from 10% to 30% impact polypropylene by weight.

Embodiment Ex34: The method of any one of Embodiments Ex26 to Ex32, wherein the polymeric layer comprises from 10% to 25% impact polypropylene by weight.

Embodiment Ex35: The method of any one of Embodiment Ex26 to Ex34, wherein the polymeric layer comprises at least 60% polypropylene by weight.

Embodiment Ex36: The method of any one of Embodiments Ex26 to Ex34, wherein the polymeric layer comprises at least 70% polypropylene by weight.

Embodiment Ex37: The method of any one of Embodiments Ex26 to Ex34, wherein the polymeric layer comprises at least 80% polypropylene by weight.

Embodiment Ex38: A blend for forming a recyclable layer of a thermoformable polymeric film, the blend comprising: (i) at least 50% polypropylene by weight, wherein the polypropylene comprises impact polypropylene and wherein the blend comprises at least 5% impact polypropylene by weight; (ii) at least 5% tackifier by weight; and (iii) from 0.1% to 5% crosslinker by weight, such as from 0.5% to 5% crosslinker by weight.

Embodiment Ex39: The blend of Embodiment Ex38, wherein the polymeric layer comprises from 1% to 3% of the crosslinker by weight.

Embodiment Ex40: The blend of Embodiment Ex38, wherein the polymeric layer comprises from 1.5% to 2.5% of the crosslinker by weight.

Embodiment Ex41: The blend of any one of Embodiments Ex38 to Ex40, wherein the crosslinker comprises an ionic crosslinker.

Embodiment Ex42: The blend of any one of Embodiments Ex38 to Ex41, wherein the polymeric layer comprises from 5% to 40% tackifier by weight.

Embodiment Ex43: The blend of any one of Embodiments Ex38 to Ex41, wherein the polymeric layer comprises from 10% to 25% tackifier by weight.

Embodiment Ex44: The blend of any one of Embodiments Ex38 to Ex41, wherein the polymeric layer comprises from 15% to 20% tackifier by weight.

Embodiment Ex45: The blend of any one of Embodiment Ex38 to Ex43, wherein the polymeric layer comprises from 10% to 30% impact polypropylene by weight.

Embodiment Ex46: The blend of any one of Embodiments Ex38 to Ex43, wherein the polymeric layer comprises from 10% to 25% impact polypropylene by weight.

Embodiment Ex47: The blend of any one of Embodiment Ex38 to Ex46, wherein the polymeric layer comprises at least 60% polypropylene by weight.

Embodiment Ex48: The blend of any one of Embodiments Ex48 to Ex46, wherein the polymeric layer comprises at least 70% polypropylene by weight.

Embodiment Ex49: The blend of any one of Embodiments Ex38 to Ex46, wherein the polymeric layer comprises at least 80% polypropylene by weight.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as, an acknowledgment or any form of suggestion that they constitute valid prior art or form part of the common general knowledge in any country in the world.

### EXAMPLES

In Examples 1 and 2 that follow, single layer sample films were formed from various blends and the sample films were thermoformed by a one-up former in a prototype lab. The one-up former had an infrared oven for heating, which lacked temperature control. The preheat dwell time was modified to control the amount of heat received by the films. Once a desired preheat dwell time/temperature was reached, a vacuum was engaged to form into the mold.

In Examples 1 and 2, representative results are shown. Varying other crosslinker percentages or percentages and types of impact polypropylene (PP), and PP were used and produced similar results (data not shown).

### Example 1: Thermoforming Below Melting Point

Tackifier was added to polypropylene (PP) blends to form films to determine thermoformability of the resulting films. Without intending to be bound by theory, it is believed that as the film temperature approaches the Tg of the tackifier, the tackifier material mobilizes and the space previously occupied by the tackifier becomes available for neighboring PP chains to occupy. This enhanced PP chain mobility reduces the lower temperature limit for forming and broadens the thermoforming window (relative to PP without tackifier and thus without additional space when heated).

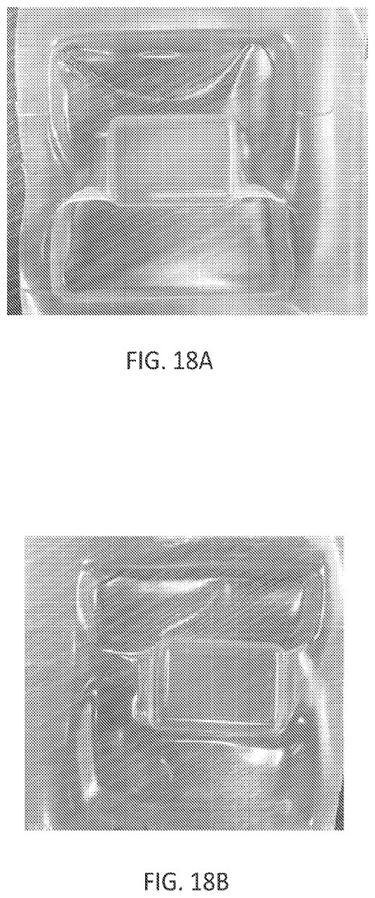

Single layer films were made from a PP homopolymer (Braskem INSPIRE 6021N) and a blend of 30% by weight tackifier (Plastolyn® R1140 hydrocarbon resin available from Synthomer plc) and 70% by weight PP homopolymer (6021N). Trays were thermoformed from the films on the one-up former (7 second preheat dwell time) using the same preheat dwell time for each film. Images of the resulting trays are shown in FIG. 12A (PP control, no tackifier) and FIG. 12B (PP+30% tackifier). As shown in FIGS. 12A-B, the sample containing tackifier resulted in substantially improved tray formation, indicating improved thermoformability.

It was noted that the sample containing tackifier was very brittle and easily broke apart. In an attempt to reduce brittleness, an impact PP (Total (TotalEnergies) 4170) was added to the PP homopolymer+tackifier blend. The addition of the impact PP reduced brittleness and seemed to enhance thermoformability. The images shown in FIGS. 13A-B show results of trays thermoformed (7 second preheat dwell time) from films formed from a blend of 20% by weight tackifier (Plastolyn™ R1140) and 80% by weight PP homopolymer (6021N) and from a blend of 20% by weight tackifier (Plastolyn™ R1140), 20% by weight impact PP (4170), and 60% by weight PP homopolymer (6021N). FIG. 13A shows a tray thermoformed from a single layer film formed from 20% tackifier and 80% PP homopolymer. FIG. 13B shows a tray thermoformed from a single layer film formed from 20% tackifier, 30% impact PP (4170), and 50% PP homopolymer. As shown, the tray in FIG. 13B is markedly better formed than the tray in FIG. 13A, indicating that the impact PP improves thermoformability. Accordingly, the impact PP may enhance thermoformability and reduce brittleness resulting from the use of the tackifier.

Different tackifiers and impact PPs and different weight percentages were tested. The images shown in FIGS. 14A-B show results of trays thermoformed from films formed from a control PP homopolymer (6021N) (14A) and from a blend of 27% by weight tackifier (Plastolyn™ R1140), 10% by weight impact PP (LyondellBasell Adflex Q100F), and 63% by weight PP homopolymer (6021N) (14B). As shown, a film formed from a blend having a different impact PP at a different weight percent and a different weight percent of tackifier still resulted in a substantially improved thermoform tray than the control PP, indicating that components and weight percentages may be varied.

### Example 2: Thermoforming Above PP Melting Point

While the addition of tackifier improves thermoformability of PP below the melting temperature of the PP, the addition of tackifier increases the melt strength of the PP. For example, FIGS. 15A-B show images of films subjected to thermoforming on the one-up former with an 18 second preheat dwell time. The film in FIG. 15A was made from a PP homopolymer (6021N). The film in FIG. 15B was made from a blend of 30% by weight tackifier (Piccolyte® S135 polyterpene resin available from Pinova, Inc.) and 70% by weight PP homopolymer (6021N). As shown, the film containing the tackifier melted and had large holes (FIG. 15B), relative to the film without tackifier (FIG. 15A).

The effects of a crosslinker were determined. Without intending to be bound by theory, it is believed that a crosslinker will increase the melt strength of a PP blend at temperatures just below the melting point, improving sag resistance at thermoforming temperatures. Sagging may be problematic when thermoforming, as a sagging film may stick to the mold.

An ionic crosslinker is believed to provide a thermally reversible, dynamic crosslinked network. At high temperatures like those used in extrusion processing, the ions are disassociated and thus, do not significantly influence PP chain motion or processing. However, at temperatures near PP's melting point like those used in thermoforming, ions attached to neighboring chains form aggregates or clusters that restrict PP chain motion and effectively increase PP's extensional viscosity, sag resistance and melt strength.

In this example, Dymalink® 9200, an acrylate functional zinc salt that reacts with aliphatic polymers to form a carbon-carbon covalent link, was added to the blend. Adding Dymalink® 9200 at 1.5% by weight to a blend of PP homopolymer (6021N) and 15% by weight tackifier (Piccolyte $135) or to PP homopolymer, significantly improved extensional viscosity (sag resistance) in both the machine direction (MD) and transverse direction (TD) of single layer films. Extensional viscosity (Pa s) values for such films are shown in Table 1.

Elongational viscosity was measured. One way to measure elongational viscosity includes compression molding samples from pellets into 2 mm thick films. The pellets may be melted at 210° C. for 5 minutes with the mold resting in contact with both the top and bottom platens. Then, 20,000 lbs of pressure may be applied for 2 minutes. The sample may be removed and placed in a 23° C. press with 10,000 lbs of pressure to cool. Then, the sample may be removed from the mold and conditioned for 24 hours at 23° C. with 50% humidity before measuring elongational viscosity. Sample strips measuring 4 mm by 12 mm strips may be cut into the compression molded 2 mm films and loaded into a TA Instruments DHR-2 with a SER3 universal testing platform attachment. The sample may receive a temperature soak of 170° C. for 300 seconds, and then an extensional rate of 0.1 s⁻¹ at 170° C. may be applied until a final strain of 4.0 is reached. The peak elongational viscosity measured according to this method may be reported as the elongational viscosity value. Examples of a method and apparatus (Sentmanat Extension Rheometer) for measuring the elongational viscosity are described in U.S. Pat. Nos. 6,578,413 and 6,691,569, the contents of which are hereby incorporated herein by reference in their respective entireties to the extent that they do not conflict with the disclosure presented herein.

TABLE 1
Elongational Viscosities

| Film Composition | TD (Pa s) | MD (Pa s) |
|---|---|---|
| PP1 | 49,000 | 40,000 |
| PP1 + X | 1,026,000 | 3,222,000 |
| PP2 | 429,000 | 128,000 |
| PP2 + X | 1,323,000 | 1,385,000 |

In Table 1, PP1 is PP homopolymer (6021N), PP1+X is PP homopolymer (6021N) and 1.5% by weight crosslinker (Dymalink® 9200), PP2 is a blend of PP homopolymer (6021N) and 15% by weight tackifier (Piccolyte S135), and PP2+X is a blend of PP homopolymer (6021N) and 15% by weight tackifier (Piccolyte S135) and 1.5% by weight crosslinker (Dymalink® 9200). As shown, the addition of a crosslinker results in markedly higher elongational viscosities, which should produce substantially less sagging.

Extent of sagging, and improvement with a crosslinker, can also be seen in FIGS. 16A-C, which are images of film held on opposing ends. The film in FIG. 16A is a PP homopolymer (6021N) film, the film of FIG. 16B is a PP homopolymer (6021N) and 30% by weight tackifier (Plastolyn S135) film, and the film of FIG. 16C is a PP homopolymer (6021N), 30% by weight tackifier (Plastolyn S135), and 2.5% crosslinker (Dymalink® 9200) film. As shown, the film with the tackifier (16B) exhibits substantial sagging, which is markedly improved (less sagging) with the addition of the crosslinker (16C).

The addition of a crosslinker not only reduced sagging but also improved melt strength of the PP blend films. FIGS. 17A-C show trays thermoformed from films using the one-up former for a 32 second preheat dwell time. The film in FIG. 17A is a PP homopolymer (6021N) film. The film in FIG. 17B is a blend of PP homopolymer (6021N), 20% tackifier (Plastolyn R1140), 10% impact PP (Adflex Q100F), and 2.5% crosslinker (Dymalink® 9200). The film in FIG. 17B is a blend of PP homopolymer (6021N), 27% tackifier (Plastolyn R1140), and 10% impact PP (Adflex Q100F). The film with crosslinker (17B) suitably thermoformed under these conditions, while both films without crosslinker (17A, 17C) melted and contained large holes.

The film in FIG. 18A is formed from a blend of PP homopolymer (6021N), 10% impact PP (Adflex Q100F), 20% tackifier (Plastolyn R1140), and 2.5% crosslinker (Dymalink® 9200). The film in FIG. 18B is formed from a blend of PP homopolymer (6021N), 10% impact PP (Adflex Q100F), and 20% tackifier (Plastolyn R1140). Both films suitably thermoformed, indicating that the crosslinker does not adversely affect thermoforming at the lower end of the thermoforming temperature window.

### Example 3: Determining Thermoforming Temperature Window

Three blends were formed as follows:
PP1 [PP homopolymer (6021N)],
PP2 [PP homopolymer (6021N), 20% by weight tackifier (Plastolyn R1140), and 10% by weight impact PP (Adflex Q100F)], and
PP3 [PP homopolymer (6021N)], 20% by weight tackifier (Plastolyn R1140), 10% by weight impact PP (Adflex Q100F), and 1.5% by weight crosslinker (Dymalink® 9200)].

Seven-layer films with different PP blends (PP1/PP2/PP3) were made by coextrusion. The seven layers of the films were as follows: (1) 10% PP homopolymer (6021N), (2) 35% PP blend (PP1, PP2 or PP3), (3) 2.5% tie, (4) 5% EVOH, (5) 2.5% tie, (6) 35% PP blend (PP1, PP2 or PP3), and (7) 10% PP homopolymer (6021N). The films were subjected to thermoforming on a Bosch TFA 7042 S line former. Temperature zones 1 and 2 were set to 60° C. for all films, and only zones 3, 4, & 5 were adjusted throughout the trial. Each film was run with a similar preheat plate dwell time for consistency and comparison (1.64 seconds, top/1.25 seconds, bottom). Air pressure was kept between 65-85 psi and adjusted only as needed to optimize appearance for every film/temperature combination. The quality of the thermoformed article was visually inspected and determine to be suitable or unsuitable. The temperature ranges determined to be suitable for thermoforming for each of the tested films is shown below in Table 2. Determination of the thermoforming window was described previously.

TABLE 2
Thermoforming temperature windows

| Film Composition | Thermoforming Temperature Window (C.) |
|---|---|
| PP1 | 162 to 165 |
| PP2 | 150 to 160 |
| PP3 | 150 to 165 |

As shown in Table 2, the addition of tackifier, impact PP, and crosslinker increased the thermoforming temperature window from 3 degrees C. (162 to 165) to 15 degrees C. (150 to 165). A 15 degree C. thermoforming temperature window is sufficiently large to allow for practical use of the films to produce thermoformed articles.

1. A thermoformable polymeric film comprising a polymeric layer, the polymeric layer comprising:
at least 50% polypropylene by weight, wherein the polypropylene comprises impact polypropylene and wherein the layer comprises at least 5% impact polypropylene by weight;
at least 5% tackifier by weight; and
from 0.1% to 5% crosslinker by weight.

2. The film of claim 1, wherein the polymeric layer comprises from 1% to 3% of the crosslinker by weight.

3. The film of claim 1, wherein the polymeric layer comprises from 1.5% to 2.5% of the crosslinker by weight.

4. The film of claim 1, wherein the crosslinker comprises an ionic crosslinker.

5. The film of claim 1, wherein the polymeric layer comprises from 5% to 40% tackifier by weight.

6. The film of claim 1, wherein the polymeric layer comprises from 10% to 25% tackifier by weight.

7. The film of claim 1, wherein the polymeric layer comprises from 15% to 20% tackifier by weight.

8. The film of claim 1, wherein the polymeric layer comprises from 5% to 50% impact polypropylene by weight.

9. The film of claim 1, wherein the polymeric layer comprises from 10% to 25% impact polypropylene by weight.

10. The film of claim 1, wherein the polymeric layer comprises at least 60% polypropylene by weight.

11. The film of claim 1, wherein the polymeric layer comprises at least 70% polypropylene by weight.

12. The film of claim 1, wherein the polymeric layer comprises at least 80% polypropylene by weight.

13. The film of claim 1, wherein the film consists of or consists essentially of the polymeric layer.

14. The film of claim 13, further comprising a second layer comprising polypropylene.

15. The film of claim 14, wherein the second layer comprises at least 80% polypropylene by weight.

16. The film of claim 14, further comprising a third layer comprising polypropylene.

17. The film of claim 16, wherein the third layer comprises at least 80% polypropylene by weight.

18. The film of claim 16, wherein the polymeric layer is between the second layer and the third layer.

19. (canceled)

20. (canceled)

21. (canceled)

22. A package comprising the film of claim 1.

23. (canceled)

24. (canceled)

25. (canceled)

26. A method for forming a thermoformable film layer, the method comprising:
blending polypropylene matrix polymer, an impact polypropylene polymer, a tackifier, and a crosslinker; and
forming the film layer from the blend, wherein the film layer comprises:
at least 50% polypropylene by weight, wherein the polypropylene comprises impact polypropylene and wherein the layer comprises at least 5% impact polypropylene by weight;
at least 5% tackifier by weight; and
from 0.1% to 5% crosslinker by weight.

27. (canceled)
